(19) United States
(12) Patent Application Publication
(10) Pub. No.: US 2015/0079923 A1
(43) Pub. Date: Mar. 19, 2015

(54) COMMUNICATIONS DEVICE BASED ANALYTICS FOR A TRAVELER

(71) Applicant: Joe McNeil, Apollo Beach, FL (US)

(72) Inventor: Joe McNeil, Apollo Beach, FL (US)

(21) Appl. No.: 14/460,931

(22) Filed: Aug. 15, 2014

Related U.S. Application Data
(60) Provisional application No. 61/835,909, filed on Jun. 17, 2013.

(51) Int. Cl. H04W 4/22; H04W 64/00; H04W 4/02

(52) U.S. Cl. CPC H04W 4/22; H04W 4/02; H04W 64/00
USPC 455/404.2

(57) ABSTRACT

A method for communicating traveler information is provided. The method includes: launching a telematics application on a mobile station, the mobile station including at least one sensor configured for monitoring at least one travel dynamic, wherein the mobile station is disposed in a motor vehicle; monitoring the at least one travel dynamic during a trip; and communicating monitoring data through a communications network of the mobile station. A telematics application and a telematics system are described.

### BACKGROUND OF THE INVENTION

1. Field of the Invention

The invention disclosed herein relates to methods and apparatus for monitoring and assisting a traveler, in particular, to methods and apparatus that may be deployed using a communications device such as a smart phone.

2. Description of the Related Art

as the number of people driving on the streets and highways continues to increase, so too does the risk of an accident. While many accidents may be relatively benign and simply considered to be nothing more than a “fender bender,” some accidents are substantially more severe. Regardless of the type of accident, in each instance, a loss of some kind occurs.

With the advent of cell phone technology, drivers have become well-equipped to deal with a common fender bender. That is, where minimal amount of damage is incurred, it is frequently the case that a driver will have a cell phone that enables immediate communication with local authorities and insurance providers. Further, with a cell phone that is equipped with a camera, the driver is able to take adequate pictures at the time of the accident.

However, in some instances drivers are incapacitated by the accident. Although a typical cell phone of today has a great deal of processing power, such technology is generally not equipped for aiding a person injured in an automobile accident.

### SUMMARY OF THE INVENTION

In one embodiment, a telematics application for operation on a mobile station is disclosed. The telematics application includes a computer program product stored on machine readable media, the computer program product including instructions for: monitoring position data of the mobile station and initiating data sampling upon crossing at least one positioning threshold, the threshold indicative of travel in a motor vehicle; receiving data from at least one sensor of the mobile station; qualifying the data on an ongoing basis; and at least one of communicating the data and identifying an event from the qualified data.

In another embodiment, a method for communicating traveler information is provided. The method includes: launching a telematics application on a mobile station, the mobile station including at least one sensor configured for monitoring at least one travel dynamic, wherein the mobile station is disposed in a motor vehicle; monitoring the at least one travel dynamic during a trip; and communicating monitoring data through a communications network of the mobile station.

In yet another embodiment, a telematics system is provided. The telematics system includes a telematics application for operation on a mobile station, the telematics application including a computer program product stored on machine readable media, the computer program product including instructions for monitoring position data of the mobile station and initiating data sampling upon crossing at least one positioning threshold, the threshold indicative of travel in a motor vehicle; receiving data from at least one sensor of the mobile station; qualifying the data on an ongoing basis; and at least one of communicating the data and identifying an event from the qualified data; and a telematics operator configured for receiving communication from the telematics application.

### BRIEF DESCRIPTION OF THE DRAWINGS

The features and advantages of the invention are apparent from the following description taken in conjunction with the accompanying drawings in which:

FIG. 1 is a schematic diagram depicting a telematics system according to the teachings herein; and

FIG. 2 is a schematic diagram depicting components of an exemplary communications device suited for use in the telematics system of FIG. 1.

### DETAILED DESCRIPTION OF THE INVENTION

Disclosed herein are methods and apparatus for providing a traveler with advanced telematics technology. The telematics technology is generally based in a mobile station such as a “smart phone” and may be complimented with a remote operator. The telematics technology provides users with substantial capabilities including crash detection, as well as profiling of driver behavior and other capabilities. Generally, a user will launch (or start) a telematics application on their smart phone, In some embodiments, the telematics application may be self started without user input (that is, triggered by an external event). Once the telematics application has been started, the telematics application will monitor components of the smart phone and associate the monitoring data with at least one travel dynamic.

Advantageously, the telematics technology makes use of commonly available equipment. Accordingly, the technology disclosed herein may be ported from one motor vehicle to another, used with older vehicles, and retained after disposal of a given vehicle. Further, by being available through commonly available equipment, the telematics technology provided herein provides for much greater cost effective implementations than previously available and therefore increases availability to individuals wishing to use such technology.

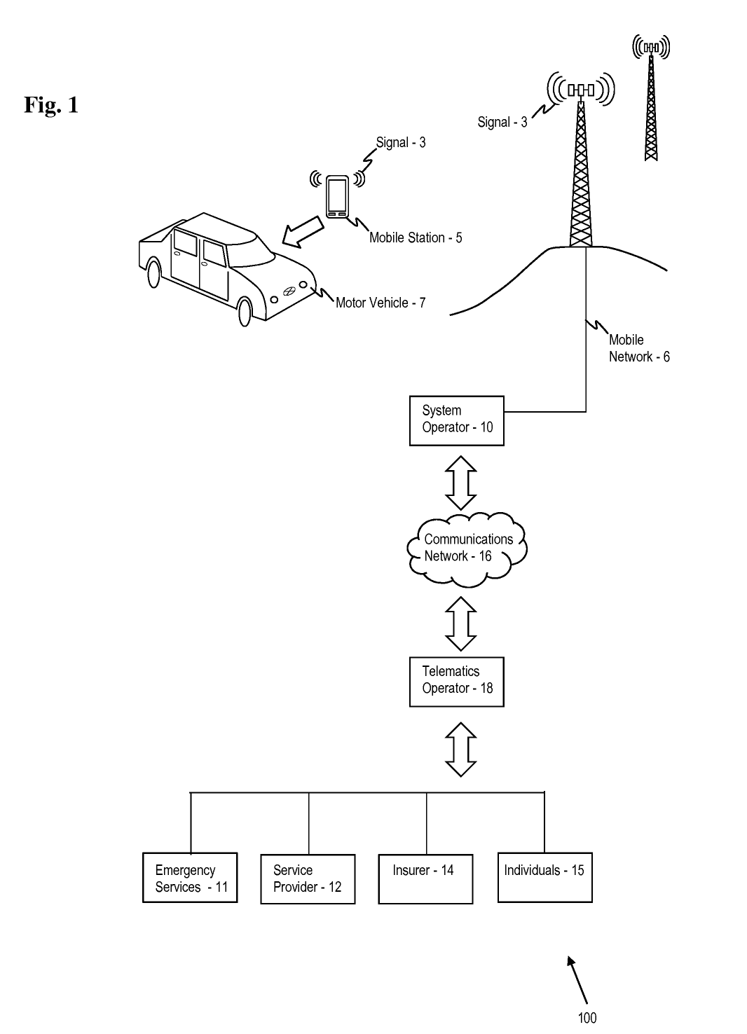

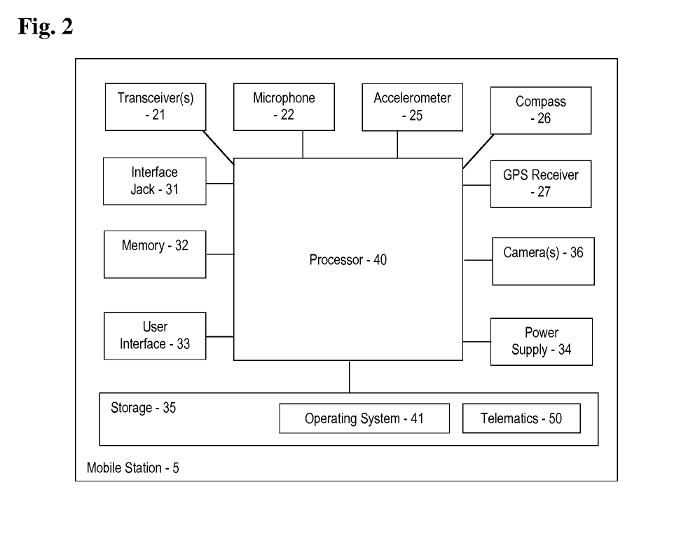

In order to provide some context for the telematics technology, an introduction is provided with reference to FIGS. 1 and 2.

Referring now to FIG. 1, there is shown an exemplary telematics system 100. The telematics system 100 generally includes mobile network 6 that is configured for communicating with at least one mobile station 5, through, for example, a cellular network. An exemplary mobile station 5 includes a “smart phone” and is discussed in greater detail with regards to FIG. 2. Generally, the mobile station 5 communicates wirelessly via a wireless signal 3. A system operator 10 of the mobile network 6 conveys communications from the mobile station 5 through a communications network 16. Telematics operator 18 includes parties responsible for administration of the telematics system 100. Exemplary parties include a call center with staff dedicated to monitoring communications from a plurality of mobile stations 5.

Exemplary embodiments of the mobile station 5 include the iPhone (available from Apple Incorporated Cupertino Calif.); a variety of Android devices (available from companies such as Motorola Mobility, LG Electronics, Samsung, HTC and others); BlackBerry devices (available from BlackBerry Incorporated, Waterloo, Ontario, Canada); devices from Nokia (of Espoo Finland) and others.

The communications network 16 may include any conventional form of communications equipment, such as traditional telephone lines, voice over Internet protocol (VoIP), additional wireless communications channels and the like. Generally, the telematics system 100 provides for one way communications or two-way communications between the mobile station 5 and another party. Exemplary parties receiving communications from the mobile station 5 include emergency service providers 11, private service providers 12, insurers 14 (and their agents), and may include specified individuals.

By way of example, if the telematics system 100 identifies a need for emergency services, then the telematics system 100 may automatically (or semi-automatically) initiate contact with at least one of police, fire and rescue personnel. Similarly, if the telematics system 100 identifies a need for other services (such as a tow truck) than the telematics system 100 may initiate contact with an appropriate service provider. Further, if the telematics system 100 identifies an appropriate event, then the telematics system 100 may initiate contact with an appropriate individual 15. Appropriate individuals 15 may include, for example, a parent, a husband or a wife or other next of kin.

In some embodiments, the telematics system 100 may be configured for providing information to an insurer 14. Information provided to the insurer 14 may be provided on at least one of a continuing basis (such as in a data stream), on a periodic basis (such as by a weekly download), or on an ad hoc basis (such as when queried by the insurer 14). Exemplary information provided to the insurer 14 may include vehicle operating characteristics useful in performing risk analysis.

Generally, the mobile station 5 will launch an appropriate application (that is, a software application, which may also be considered as a computer program product that includes machine executable instructions stored on machine readable media, the instructions for implementing features described herein).

In general terms, and as an overview, the software application draws on resources of the mobile station 5 to monitor operating characteristics during operation of a motor vehicle 7. While discussed herein as an automobile, or simply as a “car,” the motor vehicle 7 may include any type of vehicle that causes an appropriate dynamic for the software application to commence data collection. Accordingly, some of the features disclosed herein may be particularly useful in some embodiments, while not useful in others.

In some embodiments, the telematics system 100 is operated entirely from the mobile station 5, and no telematics operator 18 is included. In these embodiments, the mobile station 5 provides for fulfillment of at least some of the aspects otherwise described as being fulfilled by the telematics operator 18.

Referring now also to FIG. 2, exemplary aspects of the mobile station 5 are described. In this exemplary embodiment, the mobile station 5 includes at least one transceiver 21. The transceiver 21 may be configured for communication on at least one of the mobile network 6 (such as a cellular network), a local network (such as by Wi-Fi, or by use of 802.11 protocols), through spread spectrum technology (such as Bluetooth), through near field communications as well as any other type of wireless communication deemed appropriate.

Communications may occur using any protocol deemed appropriate. For example, the telematics application 50 may send streaming packets of data to the telematics operator 18. In some embodiments, the telematics application 50 takes advantage of at least one of SMS messaging, MMS messaging, email and any other standard protocol deemed appropriate.

The exemplary mobile station 5 includes at least one microphone 22. Additionally, the mobile station 5 includes an accelerometer 25, a compass 26, a global positioning system (GPS) receiver 27, at least one camera 36, an interface jack 31, memory 32, a user interface 33, data storage 35 and a power supply 34. At least one processor 40 is included in generally provides for management and control of the foregoing components included in the mobile station 5. In the exemplary embodiment of the mobile station 5, software applications are stored within the storage 35.

Generally, the foregoing components include additional subcomponents as may be known. For example, the power supply 34 may include at least one battery. The at least one battery may be removable or internal to the mobile station 5. The power supply 34 may include an external jack for receiving external power, such as from a direct current (DC) source.

Other components may be included in the mobile station 5. For example, a clock may be separately included, as a part of the processor 40, or provided as a signal through the transceiver 21. In some embodiments, a plurality of clock signals are available. In the interest of brevity, aspects of the foregoing components as well as other components are not discussed further here, but may be introduced as appropriate below.

Two software applications of particular interest are an operating system 41 and a telematics application 50.

A fundamental software application that is stored in the storage 35 is the operating system 41. The operating system 41 includes computer executable instructions for managing operation of the mobile station 5. This includes control of components of the mobile station 5, as well as operation of the various software applications. Generally, a variety of embodiments of the mobile station 5 may be used. As the operating system 41 includes many hardware specific commands, aspects of the operating system 41 will vary between each embodiment. Accordingly, aspects of the telematics application 50 may vary between embodiments. Generally, this variability is dependent upon capabilities of the mobile station 5 and the operating system 41.

Generally, the telematics application 50 provides instructions for use and operation of the mobile station 5 as a component of the telematics system 100. The telematics application 50 may be developed using any appropriate development tools. Appropriate development tools include, for example, software development kits (SDK) suited for a particular embodiment of the mobile station 5, and may include other tools such as development tools available on a personal computer (PC) platform. Exemplary PC-based development tools include C++.

The telematics application 50 may be installed in the mobile station 5 through conventional techniques. For example, the telematics application 50 may be downloaded to the mobile station 5 through a wireless interface, such as at least one communications channel of the transceiver 21. The telematics application 50 may be downloaded to the mobile station 5 through a wired interface, such as through the interface jack 31. The telematics application 50 may be installed in the mobile station 5 by manual addition of memory 32. In this embodiment, manual addition of memory 32 may include, for example, insertion of a memory card that includes the telematics application 50 loaded thereon.

The telematics application 50 may be stored in the mobile station 5 in any manner deemed appropriate. For example, the telematics application 50 may be stored entirely in nonvolatile storage 35. In some embodiments, the telematics application 50 may be stored at least partially in memory 32. Further, in some embodiments, at least a portion of the telematics application 50 may be obtained from a remote location. For example, the telematics application 50 may make use of a communications channel of the transceiver 21 to obtain license verification, a license code and the like. In short, the telematics application 50 may be arranged for use in the mobile station 5 in any manner deemed appropriate.

The telematics application 50 may generate additional data files during execution. The telematics application 50 may be configured to store the data files locally, such as in storage 35, to communicates the data files as appropriate, such as through the transceiver 21, and may manage the data files in any manner deemed appropriate.

Generally, the telematics system 100 relies heavily upon the telematics application 50 and the telematics operator 18. Functionality the telematics system 100 may be distributed as deemed appropriate between the telematics application 50 and the telematics operator 18. For example, the telematics application 50 may assume data collection and communication as a principal responsibility. In such embodiments, the telematics operator 18 may be principally responsible for receiving data from the telematics application 50, organizing the data, analyzing the data, reporting the data and taking appropriate actions when indicated.

The telematics system 100 is now described in greater detail, with particular emphasis on the telematics application 50 area

Generally, the telematics application 50 uses sensors available in the mobile station 5 to detect situations that might indicate that the car 7, which the mobile station 5 is traveling in, has been in an accident. For example, in some embodiments, the telematics application 50 will monitor the accelerometer 25 and the GPS receiver 27. In some embodiments, the telematics application 50 will identify an accident has occurred when traveling motion is indicated by the GPS receiver 27, a substantially abrupt change in acceleration is indicated by the accelerometer 25, and may also be followed by cessation of traveling motion as indicated by the GPS receiver 27.

Background Monitoring. In some embodiments of mobile stations 5, the operating system 41 only permits one software application to be running at any given time. No multitasking is allowed, with the exception of certain limited circumstances. When the mobile station 5 is provided as an iPhone (from Apple Incorporated, Cupertino Calif.), the telematics application 50 takes advantage of the exceptions for multitasking. Specifically, where the operating system 41 is an iOS™ operating system (also from Apple Incorporated, Cupertino Calif.), the telematics application 50 makes use of a provision for a software application to register location changes while in the background.

Embodiments of the telematics application 50 are now described in greater detail with regards to an iPhone and an iOS operating system. Accordingly, specific variables and structures discussed herein may be unique to the iOS operating system. However, it should be considered that these embodiments are merely exemplary Internet limiting of the teachings herein. For example, the telematics application 50 may be configured to operate on an Android™ operating system (available from Google Incorporated, Mountain View Calif.); Blackberry systems (available from Blackberry Incorporated, Waterloo, Ontario, Canada); a Windows™-based smart phone (where Windows refers to an operating system available from Microsoft Corporation, Redmond Wash.); and may include other systems, such as proprietary systems developed for fleet operations as well as other similar systems. Accordingly, similar variables and structures may be found in these other operating systems, or may be omitted. In some embodiments, particularly where the structures and variables discussed herein are omitted, other techniques may be used for providing the functionality discussed herein.

When registering for location changes, the telematics application 50 request notification of the smallest GPS location change possible. This allows the telematics application 50 to detect situations such as a car crash where the speed is reduced significantly over a very short period of time.

As GPS data arrives, the data is processed in real-time to determine if the data stream matches one of the predetermined conditions for taking an action, such as conditions for an accident and contacting emergency services 11. If a condition is met, then the corresponding alert is generated and/or other suitable action is taken.

In some embodiments, data from the GPS receiver 27 (that is, position data or GPS data) is continuously stored in a local database for later use.

An iOS application that is running in the background receiving GPS data can monitor the accelerometer 25. In some embodiments, the telematics application 50 uses accelerometer data to identify a spike in G-forces that might indicate a car crash. The data stream from the accelerometer 25 is monitored for certain preset conditions, and an alert is generated when one is met, in a manner similar to the handling of the GPS data described above. In some embodiments, accelerometer data is not continuously stored in the local database. Accelerometer data is only saved when an alarm occurs, or a predetermined threshold has been reached.

Location Manager. The class in iOS responsible for reporting GPS data is called “CLLocationManager.” This class is initialized as soon as the telematics application 50 is launched. CLLocationManager is configured to report location changes with an accuracy of kCLLocationAccuracyBestForNavigation and a distance filter of kCLDistanceFilterNone.

To receive location data while the telematics application 50 is processed in the background, the following entry may be added to the Info.plist file:

<key>UIBackgroundModes</key>
<array>
<string>location</string>
</array>

Should the GPS receiver 27 not be available in the mobile station 5 hosting the telematics application 50, then the initialization described above may be skipped without exiting or causing any errors in operation of the telematics application 50.

Motion Manager. There are several ways to receive accelerometer data in iOS. In some embodiments, the telematics application 50 uses the class called “CMMotionManager.” This class is also initialized as soon as the telematics application 50 is launched. CMMotionManager may be configured to report accelerometer data at the highest frequency possible. In some embodiments, accelerometer data is collected at a frequency of about 100 Hz.

Should the accelerometer 25 not be available in the mobile station 5 hosting the telematics application 50, then the initialization described above may be skipped without exiting or causing any errors in operation of the telematics application 50.

Alerts. When the telematics application 50 detects a situation that indicates that a crash of the car 7 might have occurred, then a notification is automatically sent via the operating system to be system operator 10. In some embodiments, another application may integrate with the telematics application 50 and subscribe to these notifications and take an appropriate action. In some embodiments, another application may integrate with the telematics application 50 using call-back methods.

If the telematics application 50 is currently processing in the background, then the number of actions telematics application 50 can perform may be limited by the operating system 41. Some tasks that are often performed in the background (such as calling a web service to alert someone about a situation), are possible. In some embodiments, to bring the telematics application 50 to the foreground, the telematics application 50 can immediately generate a local notification which will show up as an alert on a screen of the mobile station 5. The user can then decide to ignore the notification, or to view more details. In the latter case, the telematics application 50 will immediately be brought to the foreground.

Filtering. In some embodiments, and in order to avoid false alarms, the telematics application 50 may be configured to only generate crash alerts when certain minimum thresholds or requirements are met. Exemplary minimum thresholds include: a requirement that the mobile station 5 must be traveling at a predetermined minimum speed; a requirement that the mobile station 5 experience a predetermined minimum rate of deceleration; and by coupling accelerometer data with GPS data.

Implementations of filter criteria selected to ensure reliable identification of incidents may be stored on servers of the telematics operator 18 to allow fine tuning without redeploying all the telematics application 50.

Additional Data. While the telematics application 50 is running in the background, it may also monitor other processes running on the mobile station 5. In some embodiments, when a crash situation is detected, the names of the running processes that changed just before the event are saved. This information may indicate that the device owner launched text messaging app or other services just before the crash was detected.

Saved Data. GPS data may be continuously saved in a local database while the mobile station 5 is in motion. In some embodiments, the data may be organized into distinct trips, with the mobile station 5 being at rest in between.

While driving, data indicating significant speed changes may also be stored and later analyzed. Such event data may be useful to identify patterns of reckless driving.

When a crash event is detected, all relevant data surrounding that event may be stored in a database.

The telematics operator 18. Data stored locally in the telematics application 50 (such as in a local database) may be periodically communicated to the telematics operator 18. The telematics operator 18 may compile larger sets of data, and may employ enhanced processing techniques to provide additional functionality to the telematics system 100. For example, the telematics operator 18 may evaluate operator performance over an extended duration such as a long trip, or by providing comparative analyses of drivers skill and risk profile.

Having thus introduced the telematics system 100, additional aspects and embodiments are now discussed.

The telematics system 100 may include a plurality of software algorithms to collect information about a user from their respective mobile station 5. Exemplary information collected may include: time—through interaction with the processor (CPU) found on every modern smartphone; location—through interaction with a GPS receiver found on nearly all modern smart phones; velocity (speed)—through interaction with a GPS receiver found on nearly all modern smart phones; acceleration and deceleration forces—through interaction with an accelerometer that is found on nearly all modern smart phones.

In some embodiments, location information or position data may be collected from the GPS receiver, and/or from the communications network. That is, in addition to the GPS receiver, known techniques for identifying location of a mobile station include triangulation of a signal from the mobile station using a plurality of antenna (each antenna being located, for example, on a respective cell phone power) in the communications network.

In some embodiments, the telematics system 100 continually logs data from the mobile station 5, including: time, location, velocity, acceleration/deceleration, information about what other functions the user may be interacting with (text, calls, games, GPS), what the condition of the phone is (battery life, cellular signal strength, CPU usage and space). The speed with which these data points are logged is known as the “polling frequency.” Data collection rate may be as rapid as 0.01 seconds all the way up to several seconds apart. This range is predicated on hardware restrictions of each device and what specific sensitivity has been defined in the settings. The data collection rate may be selected in order to best suit the conditions in which a user may find themselves. Each data point may be logged, time stamped and provided with GPS coordinates, an accelerometer reading, and other unique information such as a device ID number from the mobile station 5 that is used to identify each specific user.

Generally, the telematics application 100 uses data collected for two processes; identifying incidents such as car crashes, and profiling driver behavior. Further aspects of each are now discussed.

Identification of an incident such as a car crash:

Ready state. In some embodiments, a software algorithm in the telematics application 50 constantly monitors for movement of the mobile station 5 through use of the GPS receiver 27 to detect the start of a “trip.” As a matter of convention, and for purposes of discussion herein, a “trip” is identified as beginning once the movement of the mobile station 5 exceeds a certain speed (for example, at twelve miles per hour). As the average person cannot run this fast for a sustained period of time, the telematics application 50 may be thus configured to identify the user of the device/user is likely traveling in a car or on a motorcycle. In other instances, a trip may be identified when the mobile station 5 looses a specific Wi-Fi signal. Many people have wi-fi devices in or near their homes or places of work that indicate a constant presence at a particular location. When a user travels outide of that wi-fi range, it “wakes” the application to a check other receivers such as GPS to confirm a trip has began. The polling of the mobile station 5 continues to monitor speed until which time the user becomes stationary for greater than five minutes, indicating the end of a trip. While a trip is occurring, the mobile station 5 monitors for events that may indicate a crash has taken place. In some embodiments, the telematics application 50 also compares the speed to map information to determine if the trip being taken is on a road—thus providing additional assurance that a trip in a vehicle is taking place. In this way, the telematics application 50 may be better configured to eliminate false alerts that could take place if the phone was thrown or dropped for example.

Velocity/speed change. In some embodiments, the telematics application 50 is configured to monitor the GPS readings of a user's constant velocity/speed during a trip, and to identify sharp decreases that aren't re-creatable in instances aside from an incident such as a car crash. For example, a typical car traveling sixty miles per hour is able to decelerate to zero miles per hour in five seconds or 130 feet. Even high performance cars such as the Ferrari 458 are only able to decelerate from sixty to zero miles per hour in 3.2 seconds or 95 feet. Compare that with the deceleration speed of an average sized car that crashes into barrier at sixty miles per hour, and the decoration speed is 0.05 seconds, or five hundredths of a second. By polling the GPS for a speed reading to create a “time stamped speed record,” and cross-referencing that record the one that immediately preceded it, the software is able to determine how quickly the speed changed. In the event the speed slowed greater than twenty miles per hour over the course of one second, thus exceeding the braking ability of even the highest performing road car, the software logs the event as a crash and begins cross-referencing against other data readings such as the “ready state” or the “g-force” to confirm or disallow the record.

G-force. Another part of the crash detection process involves the telematics application 50 charting changes in G-force as read by the accelerometer 25. This function is useful because it allows the telematics a occasion 50 to distinguish G-force from a normal event like a braking situation from a car crash. For example, when even the best performing road going sports cars in the world brake as quickly as they can (the Bugatti Veyron SS is claimed to be able to brake at 1.4 g), none of them are able to decelerate causing a force of greater than 1.0 g to 1.5 g. Conversely, when an average sized car crashes with a stationary barrier at twenty miles per hour, the typical impact is over 15.0 g. The telematics application 50 may be configured to differentiate a car crash from a hard brake, in part, because of the massive difference in g-force. In the event the g-force reading exceeds 1.4 g, thereby exceeding the braking ability of any road car, the software logs the event as a crash and begins cross-referencing against other data readings such as the “ready state” or the “velocity/speed change” to confirm or disallow the record.

In some embodiments, once a trip has been identified, a velocity/speed deceleration has taken place that exceeds twenty miles per hour/sec, and a g-force reading of greater than 1.4 g has taken place—a crash is determined to have taken place and the incident is logged. At this point a variety of things can take place. A pop-up indicator screen can be presented to the user on their mobile station 5 to ask if they need assistance. A call can automatically be placed from the mobile station 5 of the user to telematics operator 18 to request emergency services, and/or from the telematics operator 18 to the mobile station 5. A text message may be sent from the mobile station 5 to predetermined number(s), a message can be sent to the mobile station, and/or data reflective of the incident can be transferred to a third party such as emergency services or an insurance company. 5. An email can be sent from the mobile station 5 to a predetermined address(es), and/or an email can be sent to an email address of the user. A report of the incident, including events that lead up to the crash can be generated and sent or transferred to a third party.

Profiling driver behavior. The telematics system 100 is designed to gather numerous data points in order to build an accurate profile of a driver's behavior. Through the collection of the unique data points, the telematics system 100 is able to more accurately profile and rate driver behavior and risk. By accurately profiling each driver, insurance risk may be graded and priced with greater precision. A secondary use for this data is to construct an overall profile of an age range, ethnic range, time of travel range, or various other ranges in order to more accurately determine actuarial tables for insurance providers to base policy pricing upon. Yet another use for this data is to reconstruct events that lead up to an incident such as a car crash in order to determine liability for the insurer.

In general, the telematics application 50 is capable of monitoring a broad array of characteristics. Some examples are provided below.

Typical location of user. Often times it is important to determine where a driver resides or works in order to determine insurance risk. There's a great deal of fraud where drivers misrepresent their location, and the telematics system 100 may be configured to provide precise geo-locating to minimize misrepresentation.

Number of miles traveled over a period of time. Insurance rates can be tied to the number of miles a person drives. The telematics system 100 may be configured to provide for accurate logging of the miles a driver drives over a period of time.

Time of each trip. The time a trip is taken can be an identifier for risky driving behavior. Rush hour trips are statistically more dangerous and likely to have an incident such as crash than weekend mornings. Trips taken between midnight and 4 A.M. are noted to be the most dangerous period of time a driver can be on the road—and this would indicate very risky behavior.

Location of each trip. There are areas that are higher risk to travel in than others, such as city driving. Collecting location data for users allows for better profiling of the driver. This also enables the telematics system 100 to provide “geo-fencing” for third parties in the event the user is instructed not to travel outside of a specific area. Some parents and many fleet vehicle operators use this information to better understand the actions of their drivers or children.

Duration of each trip in time. Long trips without rest breaks are statistically more risky than short time trips. Collecting time logs helps determine if a driver is more likely to take short/long trips and this enables better risk analysis.

Length of each trip in miles. Related to the duration, the number of miles driven by a driver is an indicator they spend more time than average behind the wheel per trip. Some insurance carriers assign a lower risk to drivers that spend the majority of their trips on the “highway” as opposed to city travel.

Rapid acceleration. Some drivers rabbit start from intersections or while overtaking other vehicles on the road. This is risky behavior and assists in profiling driver behavior.

Rapid deceleration. Some drivers brake in very short spans or in dangerous areas such as on highways. This is risky behavior and assists in profiling driver behavior.

Fast turns. Cornering speed may be determined with this function, which allows the telematics system 100 to compare the speed of a driver with what has been determined to be reasonable by a third party such as an insurer, or a posted local speed limit.

Travel Speed. This data point allows the telematics system 100 to profile speed of a driver. Speed data may be used to compare against safe operating speed or posted speed limits to determine if the driver is behaving unsafely.

Aggressive Driving. An insurance company may view certain behavior as aggressive, such as weaving through traffic. The software is able to determine when these events occur by use of the GPS function and comparison against a set of allowable lane changes over a predetermined distance.

Accidents (reported or unreported). By using the crash detection portion of the telematics system 100, it is possible to determine if a user had an accident that they failed to report to an insurance company. This can happen for a variety of reasons including intoxication, unsafe operation, unauthorized operation, or because the driver moves the vehicle and fraudulently reports what occurred. The software is able to compile such behavior into a driver report to determine the risk for fraud.

Use of phone for calling while driving. Talking on the phone is considered distracted driving, and statistically it contributes to 25% of the car crashes in the US. Determining a driver's propensity to talk on the phone while driving is a key component to determining their risk as a driver and to assist in profiling their behavior.

Use of phone for texting or instant messaging while driving. According to studies, over one third of drivers (37%) have sent or received text messages while driving, and 18% said they do it regularly. For every six seconds of drive time, a driver sending or receiving a text message spends 4.6 of those seconds with their eyes off the road. This makes texting the most distracting of all cell phone related tasks. This makes the ability to determine if a driver texts or instant messages while driving a critical component of determining driver risk.

Use of phone for playing games while driving. Playing games on a smart phone while driving constitutes distracted driving and it takes the driver's attention away from driving which is high risk behavior. The telematics system 100 is able to determine if the user is manipulating their smart phone while they are in motion in order to assign a risk or grade to that behavior.

Use of phone for browsing internet while driving. According to a HealthDay poll, about 13% of adult drivers have surfed the Internet while driving. Distracted driving is a critical piece missing from existing driver profile tools, and the telematics system 100 may be configured to gather information as to whether or not a driver was browsing the Internet to better understand and more accurately profile driver behavior.

Use of phone for taking photos or video while driving. Any time a driver is taking photos or video while driving, they're putting themselves and others at risk. The ability to determine if a driver is using their smart phone to take photo or video is another critical component of determining risk.

Use of phone for playing music while driving. Interacting with a smart phone device to play music while driving is yet another distraction many people engage in while driving. The telematics system 100 is able to determine if these actions are taking place and log the time/duration of each incident in order to profile a driver's behavior.

Use of phone for GPS mapping while driving. Another key component in assigning risk or understanding driver behavior is the ability to determine if they are distracted by using the map features on a GPS phone. Forty-one percent of adult drivers have set or changed a GPS system while driving, and 21% do it “more frequently.”

It should be recognized that aspects of the telematics system 100 may be deployed in a manner that the parts from the specification provided herein. For example, the telematics system 100 may take advantage of distributed computing, and assign at least some of the tasks of the telematics application 50 (that is, the software application running on the mobile station) to the telematics operator 18. Accordingly, this may provide for substantially greater computing power, expedient processing, and a more meaningful user experience. Therefore, while this specification describes embodiments of the telematics application 50, is not to be construed as limiting of the processing, software components, and operation, and should consider the telematics operator 18 as being available to provide additional capabilities as deemed appropriate.

Generally, the term “accident” as used herein refers to a dangerous and unanticipated travel condition where the health and/or safety of a traveler may be in jeopardy. However, accidents may involve conditions where health and/or safety of a traveler is not particularly in jeopardy, and may merely result in unanticipated property damage.

Generally, the term “algorithm” as used herein refers to any method for aggregating and/or analyzing monitoring data. A plurality of algorithms may be used by the telematics application and/or the telematics operator. For example, one algorithm concerns determination of an accident. In this example, the algorithm monitors positional data (including speed), accelerometer data (to identify instantaneous deceleration), and may again continue monitoring positional data for some period of time to confirm cessation of travel. If respective setpoints or threshold values for any algorithm are crossed, then at least one of the telematics application and the telematics operator may provide a “determination.” That is, the various algorithms may provide decisions and results, or assist in reaching a decision or a result.

As discussed herein, the term “automatically” generally refers to execution of a process that is triggered and proceeds without human input. Additionally, the term “semi-automatically” generally refers to execution of a process that is at least one of triggered and proceeds with partial human input. Wherever possible, the telematics application 50 may be configured for automatic as well as semiautomatic processing. Accordingly, these terms and other similar terms may be used interchangeably herein. However, such usage is non-limiting and should be construed broadly.

Generally, the term “monitoring data” as used herein refers to any data collected by the telematics application that is indicative of travel by a user. Monitoring data may include raw output from a single sensor, a plurality of sensors, and may include aggregations or combinations of data that are indicative of travel by a user. Accordingly, a summary may include monitoring data.

Generally, the term “multitasking” refers to simultaneous operation of at least two software applications. Multitasking is managed by a respective operating system. Generally, the operating system adopts one of many different scheduling strategies for managing resources. As a result, it may appear to a user that the at least two software applications are simultaneously processing. In addition, some software applications may operate at least partially in the “background.” Generally, background processing requires fewer resources, and may not enjoy priority access to the processor (that is, background processing will proceed while the processor is in an idle state). Common tasks for background processing include data logging, system monitoring, scheduling, user notification, and routine data communication.

As discussed herein, the term “real-time” generally refers to execution of a process at a pace that is adequate to be responsive to system input. For example, if a sensor of the mobile station 5 collects a data point every second, then real-time communication of that data would proceed every second. However, it should be noted that adequate performance of the mobile station 5 may be achieved by performing some tasks in substantially real-time, or nearly in real time (that is, at some periodic interval that is adequate to provide for a desired level of performance). Accordingly, these terms as well as other similar terms such as “continuous” and “periodic” should be construed, at a minimum, to provide for a desired level of performance.

Generally, the term “summary” as used herein refers to a digest of monitoring data. The digest monitoring data may be provided by the telematics application and/or the telematics operator. A summary may include averaged data from a single sensor, instantaneous data from a plurality of sensors, and any other shortened or condensed form of monitoring data.

Various other components may be included and called upon for providing for aspects of the teachings herein. For example, additional materials, combinations of materials and/or omission of materials may be used to provide for added embodiments that are within the scope of the teachings herein.

When introducing elements of the present invention or the embodiment(s) thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements.

While the invention has been described with reference to exemplary embodiments, it will be understood by those skilled in the art that various changes may be made and equivalents may be substituted for elements thereof without departing from the scope of the invention. In addition, many modifications will be appreciated by those skilled in the art to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A telematics application for operation on a mobile station, the telematics application comprising:
a computer program product stored on machine readable media, the computer program product comprising instructions for:
monitoring position data of the mobile station and initiating data sampling upon crossing at least one positioning threshold, the threshold indicative of travel in a motor vehicle;
receiving data from at least one sensor of the mobile station;
qualifying the data on an ongoing basis; and
at least one of communicating the data and identifying an event from the qualified data.

2. The application as in claim 1, wherein the positioning data comprises location information received from at least one of a global positioning system (GPS) receiver and derived from a communications network.

3. The application as in claim 1, wherein the positioning threshold comprises a rate of travel.

4. The application as in claim 1, wherein the at least one sensor comprises at least one of a GPS receiver, an accelerometer, a camera, a compass, and a microphone.

5. The application as in claim 1, wherein communicating the data comprises transferring the data to a telematics operator.

6. The application as in claim 1, wherein identifying an event comprises identifying an accident.

7. The application as in claim 6, wherein identifying an accident comprises at least one of identifying an abrupt termination of the travel from the position data and identifying substantial deceleration.

8. A method for communicating traveler information, the method comprising:
launching a telematics application on a mobile station, the mobile station comprising at least one sensor configured for monitoring at least one travel dynamic, wherein the mobile station is disposed in a motor vehicle;
monitoring the at least one travel dynamic during a trip; and
communicating monitoring data through a communications network of the mobile station.

9. The method as in claim 8, wherein the mobile station comprises a cellular telephone.

10. The method as in claim 8, wherein the mobile station comprises at least one of a global positioning system (GPS) receiver and an accelerometer.

11. The method as in claim 8, wherein the travel dynamic comprises at least one of position, speed, a rate of acceleration, a rate of deceleration, a distance traveled, a time interval and a combination thereof.

12. The method as in claim 8, further comprising analyzing the monitoring data to determine a travel condition.

13. The method as in claim 12, wherein the travel condition comprises an accident.

14. The method as in claim 8, wherein the monitoring data communicated comprises a summary of the travel dynamic.

15. The method as in claim 8, wherein the communicating comprises automatically communicating monitoring data.

16. The method as in claim 8, wherein the communicating comprises providing at least one of the monitoring data and a summary to at least one of a telematics operator, emergency services personnel, insurance provider, a private service provider, and a designated individual.

17. A telematics system, comprising:
a telematics application for operation on a mobile station, the telematics application comprising a computer program product stored on machine readable media, the computer program product comprising instructions for monitoring position data of the mobile station and initiating data sampling upon crossing at least one positioning threshold, the threshold indicative of travel in a motor vehicle; receiving data from at least one sensor of the mobile station; qualifying the data on an ongoing basis; and at least one of communicating the data and identifying an event from the qualified data; and
a telematics operator configured for receiving communication from the telematics application.
